(19) United States
(12) Patent Application Publication
(10) Pub. No.: US 2008/0089642 A1
(43) Pub. Date: Apr. 17, 2008

(54) Photonic crystal sensor for small volume sensing

(76) Inventors: Annette Claire Grot, Cupertino, CA (US); Geoffrey William Burr, Cupertino, CA (US); William Paul Risk, Mountain View, CA (US); Ho-Cheol Kim, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/546,626

(22) Filed: Oct. 12, 2006

(51) Int. Cl. G02B 6/42; G02B 6/26; G02B 6/00; G02B 6/10

(52) U.S. Cl. 385/31; 385/39; 385/129; 385/122; 385/141; 385/142

(57) ABSTRACT

Photonic crystal apparatus and a method for fabricating a photonic crystal apparatus. The photonic crystal apparatus includes a photonic crystal having a dielectric body formed of a first dielectric material having relatively high index of refraction, and a periodic lattice in the dielectric body formed of a second dielectric material having a relatively low index of refraction. The second dielectric material comprises a solid-state dielectric material having a dielectric coefficient of about 2.7 or lower for providing a relatively large contrast between the index of refraction of the dielectric body and the index of refraction of the periodic lattice.

### DESCRIPTION OF RELATED ART

Photonic crystals are periodic dielectric structures that have spatially periodic variations in refractive index. With a sufficiently high refractive index contrast, a photonic bandgap can be opened in the structure's optical spectrum within which the propagation of light in a particular frequency range can be prevented. A three-dimensional photonic crystal can prevent the propagation of light having a frequency within the crystal's bandgap in all directions, however, fabrication of such a structure is often challenging. As a result, a desirable alternative may be to utilize a two-dimensional photonic crystal slab having a two-dimensional periodic lattice in which light propagating through the slab is confined in a direction perpendicular to a major surface of the slab by total internal reflection, while propagation in other directions is controlled by properties of the photonic crystal slab.

The size of the photonic bandgap in a photonic crystal scales, in part, with the refractive index contrast available. The difference in refractive index between a semiconductor material such as Si or GaAs and air (about 3.4:1) provides a reasonable contrast. However, much of the photonic bandgap is lost if air holes formed in a high-index semiconductor material become filled with a material having a refractive index higher than air. It is often difficult, however, to maintain the air holes in applications which require the photonic crystal to be buried under additional layers of subsequently processed optical and electronic devices. Also, in photonic crystal sensor devices for small volume sensing, for example, for detecting nanoparticles, it may be necessary to force a fluid within which the nanoparticles are suspended through particular portions of the device in order to maximize sensitivity, and the suspended nanoparticles may fill the air holes sufficiently to reduce the refractive index contrast.

### SUMMARY OF THE INVENTION

In accordance with the invention, a photonic crystal apparatus and a method for fabricating a photonic crystal apparatus are provided. The photonic crystal apparatus includes a photonic crystal having a dielectric body formed of a first dielectric material having a relatively high index of refraction, and a periodic lattice in the dielectric body formed of a second dielectric material having a relatively low index of refraction. The second dielectric material comprises a solid-state dielectric material having a dielectric coefficient of about 1.4 or lower for providing a relatively large contrast between the index of refraction of the dielectric body and the index of refraction of the periodic lattice. The photonic crystal apparatus can be used as an optical sensor for small volume sensing, for example, to detect the presence of nanoparticles.

### BRIEF DESCRIPTION OF THE DRAWINGS

Furthermore, the invention provides embodiments and other features and advantages in addition to or in lieu of those discussed above. Many of these features and advantages are apparent from the description below with reference to the following drawings.

FIG. 1 is a schematic top view of a two-dimensional photonic crystal slab apparatus to assist in explaining exemplary embodiments in accordance with the invention;

FIG. 2 is a cross-sectional plan view of a two-dimensional photonic crystal slab sensor apparatus according to an exemplary embodiment in accordance with the invention;

FIG. 3 is a block diagram that illustrates a sensor circuit incorporating the two-dimensional photonic crystal slab sensor apparatus of FIG. 2 according to an exemplary embodiment in accordance with the invention; and

FIG. 4 is a flowchart that illustrates a method for fabricating a two-dimensional photonic crystal slab sensor apparatus according to an exemplary embodiment in accordance with the invention.

### DETAILED DESCRIPTION OF THE EXEMPLARY EMBODIMENTS OF THE INVENTION

Exemplary embodiments in accordance with the invention provide a photonic crystal apparatus and a method for fabricating a photonic crystal apparatus.

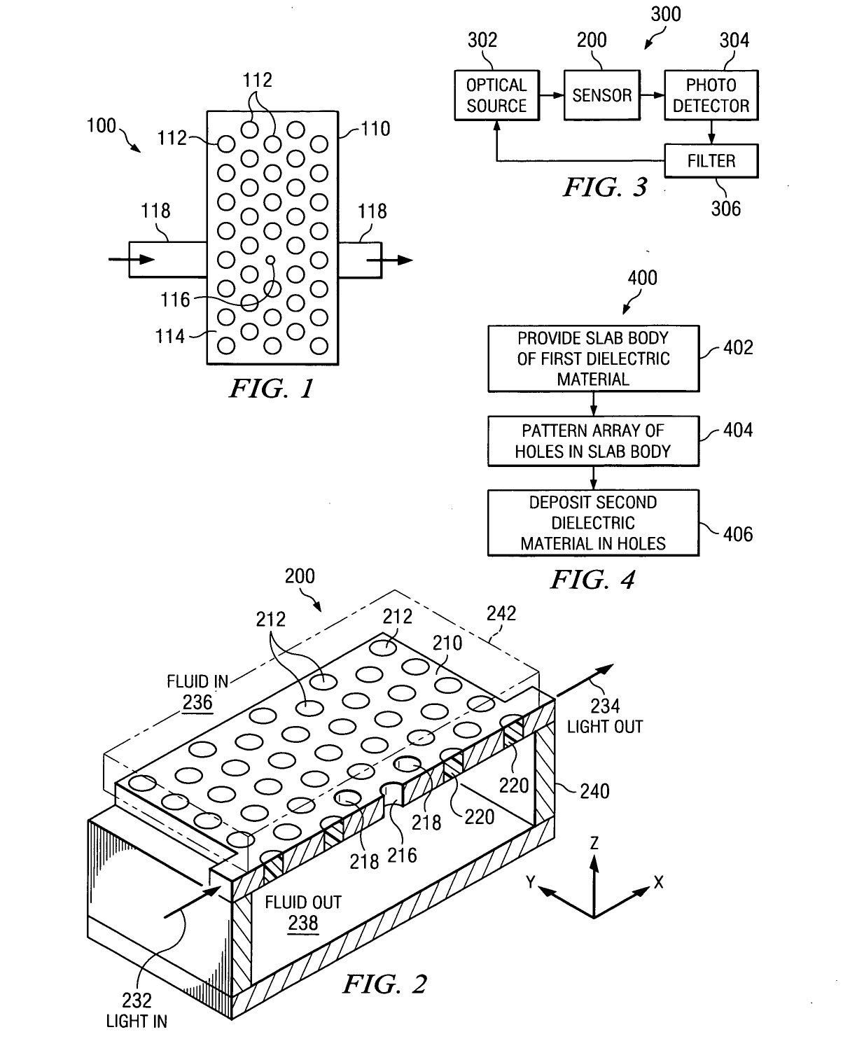

FIG. 1 is a schematic top view of a two-dimensional photonic crystal slab apparatus to assist in explaining exemplary embodiments in accordance with the invention. The apparatus is generally designated by reference number 100, and comprises a two-dimensional photonic crystal slab that includes slab body 110 having a periodic lattice in the form of an array of holes 112 extending through slab body 110 from top surface 114 to a bottom surface (not shown in FIG. 1). Slab body 110 is formed of silicon on insulator (SOI) material, GaAs, or another suitable dielectric material having a relatively high index of refraction, for example, an index of refraction of about 2.5 or higher. Holes 112 are filled with a material having a relatively low index of refraction, for example, an index of refraction of about 1.4 or lower, typically air (index of refraction of about one) or another gas.

Two-dimensional photonic crystal slab apparatus 100 comprises a periodic lattice having a rectangular array of holes 112. This is intended to be exemplary only, as holes 112 can also be arranged in other configurations, for example, a square-shaped array or a triangular-shaped array, without departing from the scope of the present invention.

Although not illustrated in FIG. 1, low index cladding layers, typically oxide films such as SiO₂ or air, are provided above and below slab body 110 to provide optical confinement in directions perpendicular to the plane of FIG. 1.

Two-dimensional photonic crystal slab apparatus 100 has a photonic bandgap that is a function of the design of the apparatus. For example, apparatus 100 can be constructed to have a photonic bandgap between about 1300 nm and about 1600 nm by etching holes 112 having a diameter of about 244 nm to define a triangular-shaped lattice having a lattice constant of about 44 nm in a Si slab material about 260 nm thick.

Additional functionality is engineered into a photonic crystal by introducing one or more defects into the otherwise periodic variation of the index of refraction of the photonic crystal. In two-dimensional photonic crystal slab apparatus 100, a single defect 116 is introduced into the periodic lattice structure defined by the array of holes 112. In particular, defect 116 is created by forming one hole of the array of holes 112 to be of a reduced diameter, for example, about 176 nm. It should be understood, however, that defect 116 can also be formed in other ways, for example, by increasing the diameter of one or more holes 112 or by changing the shape of one or more holes 112, and it is not intended to limit the invention to a defect having any particular configuration.

Defect 116 defines a resonance chamber having a resonance frequency within the photonic bandgap of two-dimensional photonic crystal slab apparatus 100 that is localized in the vicinity of the defect. Light is coupled into and out of two-dimensional photonic crystal slab apparatus 100 by light guiding structure such as ridge waveguides 118. Light at the resonance frequency can be detected in the vicinity of defect 116 using a suitable light detecting apparatus such as an InGaAs photodetector or other suitable photodetector (not shown in FIG. 1).

Two-dimensional photonic crystal slab apparatus 100 functioning as a resonator can be used as an optical sensor in the field of small volume sensing wherein the apparatus is used to detect the presence of nanoparticles, for example, biomolecules such as proteins, antibodies and viruses.

FIG. 2 is a cross-sectional plan view of a two-dimensional photonic crystal slab sensor apparatus according to an exemplary embodiment in accordance with the invention. The apparatus is generally designated by reference number 200, and comprises a two-dimensional photonic crystal slab having slab body 210 formed of silicon-on-insulator material (SOI), although it could also be formed of other appropriate dielectric materials having a relatively high index of refraction such as GaN, InP or GaAs. A two-dimensional periodic lattice is created in slab body 210 by a two-dimensional array of holes 212 formed, for example, by etching the holes through the slab body. Holes 212 are all the same diameter. A resonance chamber 216 is formed in slab body 210 by providing a single defect hole that has a diameter less than the diameter of holes 212, although, as indicated above, the defect can also be formed in other configurations and can include more than a single hole.

Slab body 210 is optically coupled to a pair of waveguides, not shown in FIG. 2, for inputting light into two-dimensional photonic crystal slab sensor apparatus 200 as shown by arrow 232, and for outputting light from the apparatus as shown by arrow 234. Optical confinement in the z-direction of two-dimensional photonic crystal slab sensor apparatus 200 is provided by low index of refraction support 240 of, for example, SiO₂ positioned below slab body 210 and by an air layer 242 (schematically shown in dotted line) above slab body 210.

Two-dimensional photonic crystal slab sensor apparatus 200 can be used to detect the presence of nanoparticles in or passing through resonance chamber (defect hole) 216. Typically, the nanoparticles are suspended in a carrier liquid such as, for example, water, and are caused to flow through the apparatus from above the apparatus to below the apparatus as indicated by the “fluid in” and “fluid out” designations 236 and 238, respectively, in FIG. 2.

The responsivity of two-dimensional photonic crystal slab sensor apparatus 200 is defined as a change in wavelength Δλ with respect to a change in refractive index Δn. For a two-dimensional photonic crystal slab sensor apparatus comprising a photonic crystal slab formed of silicon on insulator, (SOI) material, the responsivity Δλ/Δn typically ranges from about 150 nm to about 300 nm. When the refractive index changes only in resonance chamber 216 and not in the array of holes 212, the responsivity typically ranges from about 75 nm to about 150 nm. Typical dimensions for an exemplary embodiment of two-dimensional photonic crystal slab sensor apparatus 200 in accordance with the invention includes a lattice constant of about 400, a radius for holes 212 of about 0.25 a to about 0.4 a, a radius for resonance chamber 216 of about 0.15 a to about 0.25 a and a slab body thickness of about 0.6 a.

A typical volume for resonance chamber 216 is thus about 6×10⁶ nm³. Hence, a 10 nm diameter nanoparticle, such as a biomolecule, within resonance chamber 216 occupies a fractional volume of about 10⁻⁴. Most common organic molecules such as proteins, antibodies or viruses have a refractive index of about 1.5 while the refractive index of water is about 1.3. Accordingly, the presence of a single 10 nm diameter molecule in resonance chamber 216 provides a refractive index change of about 2×10⁻⁵ resulting in a shift in operating wavelength of light input into two-dimensional photonic crystal slab sensor apparatus 200 of about 0.003 nm. By detecting this change in wavelength, the presence of nanoparticles in the resonance chamber can be detected.

Individual molecules can be delivered to resonance chamber 216 using microfluidic channels or other delivery mechanisms that are well-known in the art.

Typical dimensions for biomolecules are about 2-4 nm for proteins, 4-10 nm for antibodies and 40-200 nm for viruses. Two-dimensional photonic crystal slab sensor apparatus 200 can be tuned to maximize responsivity to single nanoparticles of a particular size by varying the radii of holes 212 and resonance chamber 216 with respect to the lattice constant of the periodic lattice in slab body 210, and by determining the change in operating frequency for refractive index changes in resonant chamber 216 normalized to the volume of the defect resonance chamber.

FIG. 3 is a block diagram that illustrates a sensor circuit incorporating two-dimensional photonic crystal slab sensor apparatus 200 of FIG. 2 according to an exemplary embodiment in accordance with the invention. The sensor circuit is generally designated by reference number 300, and comprises a slope-based peak detection system that includes a narrow band optical source 302, for example, a semiconductor laser, optically coupled to two-dimensional photonic crystal slab sensor apparatus 200. The wavelength of optical source 302 switches at a frequency f₀ between two optical wavelengths, the difference between the wavelengths being kept constant by electronics in source 302, such that source 302 operates in “dither” mode.

Photodetector 304 measures the relative power transmitted at the two different wavelengths. An error signal from bandpass filter 306 centered at f₀ tunes the lower frequency or wavelength such that the current from photodetector 304 is equal for both wavelengths. The operating wavelength is then at the midpoint between the lower and upper wavelength; and, as indicated above, by measuring the operating wavelength, a nanoparticle in defect hole 216 of two-dimensional photonic crystal slab sensor apparatus 200 can be readily detected. Detection circuits such as illustrated in FIG. 3, are generally available in the art and can detect changes in wavelength of as little as 0.001 nm.

As described above, it is desirable that the index of refraction of the material in the array of holes 212 in two-dimensional photonic crystal slab sensor apparatus 200 be as low as possible to provide a relatively large contrast between the index of refraction of the slab body and the index of refraction of the periodic lattice formed by the holes, and that the index of refraction of the material in the array of holes not change during a sensing operation so that a change in the index of refraction of the material in resonance chamber (defect hole) 216 caused by the presence of a nanoparticle can be accurately detected to identify the presence of the nanoparticle in resonance chamber 216. When using two-dimensional photonic crystal slab sensor apparatus 200 to detect the presence of nanoparticles, however, it is necessary to cause a fluid within which nanoparticles are suspended to flow through resonance chamber 216, and it is difficult to do so while, at the same time, preventing fluid and particles from flowing into and through holes 212.

According to an exemplary embodiment in accordance with the invention, nanoparticles are prevented from flowing through holes 212 and the index of refraction of the material in holes 212 is maintained at a low, constant value by filling the holes with a material referred to herein as “solid air” as illustrated at 220 in FIG. 2. Solid air 220 is a solid-state dielectric material that fills holes 212 of two-dimensional photonic crystal slab sensor apparatus 200 to prevent nanoparticles or other materials from entering into holes 212 and changing the index of refraction of the material in holes 212. At the same time, material 220 has a low index of refraction approaching that of air, so as to ensure that a sufficiently large contrast is maintained between the refractive index of slab body 210 and material 220 in holes 212.

According to an exemplary embodiment in accordance with the invention, solid air material 220 comprises a solid-state dielectric material, either organic or inorganic, having a dielectric coefficient that is substantially lower than the dielectric coefficient of the dielectric material forming slab body 210. For example, a two-dimensional photonic crystal that includes a slab body formed of silicon dioxide, a commonly used dielectric material, has a dielectric coefficient K of about 4.0. When used with a silicon dioxide slab body, a suitable solid air material has a dielectric coefficient of about 2.7 or lower. The term “solid state” refers to one of the three phase of matter (solid, liquid, gas) and relates to physical properties of solid materials. A solid state material is characterized by being resistant to deformation and to change of volume.

Suitable dielectric materials include spin-on organosilicates that are used as a low-K material in back end of the line (BEOL) interconnects in semiconductor chips. The low-index organosilicates can contain intrinsic micropores or mesopores generated by porgen. The mesopores can be generated by selectively removing organic porogen molecules from phase separated organosilicate and porogen nanohybrids. The nanohybrids can be generated by thermal crosslinking of the organosilicate in a mixture of porogen and organosilicate. The amount of porogen determines porosity, hence the dielectric constant of the solid-state dielectric material. The dielectric constant of porous organosilicate generated by this method ranges from 1.2 to 2.7, and ensures that a satisfactory refractive index contrast be maintained between the material of slab body 210 and the material in holes 212 at all times.

“Solid air” material 220 can be used to fill all of holes 212 leaving only resonance chamber 216 open to receive nanoparticles. Alternatively, inasmuch as surrounding holes in the vicinity of resonance chamber 216 are also sensitive to the nanoparticles, these holes can also be left unfilled as shown at 218 in FIG. 2.

FIG. 4 is a flowchart that illustrates a method for fabricating a two-dimensional photonic crystal slab sensor apparatus according to an exemplary embodiment in accordance with the invention. The method is generally designated by reference number 400 and begins by providing a slab of silicon on insulator material (SOI) or another suitable dielectric material having a relatively high index of refraction (Step 402). An array of holes is then patterned in the SOI material, for example, by an etching process to provide a photonic crystal lattice having at least one defect hole therein (Step 404). A solid-state semiconductor material having a low dielectric coefficient is then deposited in the holes except for the defect hole, and, if desired, holes immediately surrounding the defect hole (Step 406). The material may be deposited in the holes by, for example, spin coating, dip coating, spray coating or doctor blading. The deposited dielectric material may be planarized if desired by chemical mechanical polishing (CMP) or dry etching (similar to plasma etching), and may also be treated to be either hydrophobic or hydrophilic in order to either suppress or enhance binding of small biological molecules in the suspending fluid. In this regard, the surface of fully thermally crosslinked organosilicate is very hydrophobic and shows water contact angles of about 105 deg. The surface hydrophilicity can be readily tuned by simple UV-ozone treatment. Depending on UV-ozone treatment time and temperature, the surface hydrophilicity, for example, water contact angles below 10 deg, can be controlled.

Both hydrophilic and hydrophobic dielectric materials can be used depending on how it is desired to selectively detect the nanoparticles. By tuning the surface to be either hydrophilic or hydrophobic, the binding of the nanoparticles to the porous dielectric surface can be suppressed or enhanced. This will also depend on the affinity of the nanoparticles, as well.

While what has been described constitute exemplary embodiments in accordance with the invention, it should be recognized that the invention can be varied in numerous ways without departing from the scope thereof. Because exemplary embodiments in accordance with the invention can be varied in numerous ways, it should be understood that the invention should be limited only insofar as is required by the scope of the following claims.

We claim:

1. A photonic crystal apparatus, comprising:
a photonic crystal, the photonic crystal including:
a dielectric body formed of a first dielectric material having relatively high index of refraction; and
a periodic lattice in the dielectric body, the periodic lattice formed of a second dielectric material having a relatively low index of refraction; wherein the second dielectric material comprises a solid-state dielectric material having a dielectric coefficient of about 2.7 or lower for providing a relatively large contrast between the index of refraction of the dielectric body and the index of refraction of the periodic lattice.

2. The photonic crystal apparatus according to claim 1, wherein the second dielectric material comprises a porous dielectric material, and wherein the dielectric coefficient of the second dielectric material is a function of porosity of the second dielectric material.

3. The photonic crystal apparatus according to claim 1, wherein the second dielectric material comprises an organosilicate.

4. The photonic crystal apparatus according to claim 3, wherein the organosilicate comprises spin-on organosilicate.

5. The photonic crystal apparatus according to claim 1, wherein the second dielectric material comprises one of a hydrophobic dielectric material and a hydrophilic dielectric material.

6. The photonic crystal apparatus according to claim 1, wherein the second dielectric material is planarized.

7. The photonic crystal apparatus according to claim 1, wherein the photonic crystal comprises a resonance chamber, and wherein the photonic crystal apparatus further comprises a detector for detecting a change in wavelength of light input into the photonic crystal to detect the presence of a nanoparticle in the resonance chamber.

8. The photonic crystal apparatus according to claim 1, wherein the photonic crystal comprises a two-dimensional photonic crystal slab, the dielectric body comprises a slab body, and the periodic lattice comprises a two-dimensional array of holes extending through the slab body, wherein holes of the two-dimensional array of holes are filled with the second dielectric material.

9. The photonic crystal apparatus according to claim 8, wherein the two-dimensional photonic crystal slab further comprises at least one defect hole defining a resonance chamber extending through the slab body, and wherein the photonic crystal apparatus further comprises a detector for detecting a change in wavelength of light input into the photonic crystal slab to detect the presence of a nanoparticle in the resonance chamber.

10. The photonic crystal apparatus according to claim 9, wherein the at least one defect hole comprises at least one defect hole having a cross-sectional diameter less than a cross-sectional diameter of the holes of the two-dimensional array of holes.

11. The photonic crystal apparatus according to claim 9, and further comprising at least one hole in the vicinity of the defect hole that is not filled with the second dielectric material for receiving a nanoparticle.

12. A two-dimensional photonic crystal slab sensor apparatus for detecting nanoparticles, comprising:
a two-dimensional photonic crystal slab, the two-dimensional photonic crystal slab including:
a slab body formed of a first dielectric material having relatively high index of refraction;
a periodic lattice in the slab body, the periodic lattice formed of a second dielectric material having a relatively low index of refraction; wherein the second dielectric material comprises a solid-state dielectric material having a dielectric coefficient of about 2.7 or lower for providing a relatively large and stable contrast between the index of refraction of the slab body and the index of refraction of the periodic lattice; and
at least one defect in the slab body for defining a resonance chamber; and
a detector for detecting a change in wavelength of light input into the two-dimensional photonic crystal slab to detect the presence of a nanoparticle in the resonance chamber.

13. The apparatus according to claim 12, wherein the second dielectric material comprises a porous dielectric material, and wherein the dielectric coefficient of the second dielectric material is a function of porosity of the second dielectric material.

14. The apparatus according to claim 13, wherein the porous dielectric material comprises an organosilicate.

15. The apparatus according to claim 14, wherein the organosilicate comprises spin-on organosilicate.

16. The apparatus according to claim 12, wherein the second dielectric material comprises one of a hydrophobic dielectric material and a hydrophilic dielectric material.

17. The apparatus according to claim 12, wherein the periodic lattice comprises a two-dimensional array of holes extending through the slab body, wherein holes of the two-dimensional array of holes are filled with the second dielectric material, and wherein the at least one defect hole comprises at least one defect hole having a cross-sectional diameter less than a cross-sectional diameter of the holes of the two-dimensional array of holes.

18. A method for fabricating a two-dimensional photonic crystal sensor apparatus comprising:
providing a slab body formed of a first dielectric material having a relatively high index of refraction;
patterning a periodic lattice in the form of an array of holes in the slab body, the array of holes including at least one defect hole defining a resonance chamber; and
depositing a second, solid-state dielectric material having a dielectric coefficient of about 2.7 or lower in holes of the array of holes except for the at least one defect hole for providing a relatively large contrast between the index of refraction of the slab body and the index of refraction of the periodic lattice.

19. The method according to claim 18, wherein the second solid-state dielectric material comprises an organosilicate.

20. The method according to claim 18, wherein the depositing step comprises depositing a second, solid-state dielectric material having a dielectric coefficient of about 2.7 or lower in holes of the array of holes except for the at least one defect hole and except for at least one hole in the vicinity of the defect hole.
